(19) United States
(12) Patent Application Publication
(10) Pub. No.: US 2010/0097725 A1
(43) Pub. Date: Apr. 22, 2010

(54) CARRIAGE ASSEMBLY AND STORAGE MEDIUM DRIVING DEVICE

(75) Inventors: Toru KOHEI, Tokyo (JP); Kei FUNABASHI, Shanghai (CN); Yoshihiro ARIKAWA, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/645,406

(22) Filed: Dec. 22, 2009

Related U.S. Application Data
(63) Continuation-in-part of application No. PCT/JP2007/063148, filed on Jun. 29, 2007.

(51) Int. Cl. G11B 21/16; G11B 5/48

(52) U.S. Cl. 360/246.2; 360/244; G9B/5.147; G9B/21.023

(57) ABSTRACT

According to one embodiment, a carriage assembly includes a carriage block body, a carriage arm, a coil, a pair of support arms, and a frame body. The carriage block body is rotatably connected to a spindle. The carriage arm extends forward from the front of the carriage block body. The coil is located behind the carriage block body, and defines a linear region extending along a reference straight line extending radially from the center of the spindle. The support arms extend in parallel to the linear region from a back surface of the carriage block body. The frame body is made of a resin material, and fills between the coil and the support arms to couple the coil and the support arms. The support arms extend more outside than the external end of the linear region of the coil in the radial direction.

### CROSS-REFERENCE TO RELATED APPLICATIONS

This application is a continuation of PCT international application Ser. No. PCT/JP2007/063148 filed on Jun. 29, 2007 which designates the United States, incorporated herein by reference.

### BACKGROUND

1. Field

One embodiment of the invention relates to a carriage assembly in a storage medium driving device.

2. Description of the Related Art

For example, as disclosed in Japanese Patent Application Publication (KOKAI) No. 2002-32969, a carriage is built in a hard disk drive (HDD). The carriage comprises a carriage block body that is rotatably connected to a spindle. A carriage arm extends forward from the front of the carriage block body. A pair of support arms extend backward from a back surface of the carriage block body. A coil is arranged between the support arms. The coil is attached to the support arms with a resin material.

The coil defines a linear region that extends radially from the center of the spindle. The coil faces a permanent magnet of a voice coil motor (VCM) in the linear region. As illustrated in FIG. 3 of Japanese Patent Application Publication (KOKAI) No. 2002-32969, an external end of the support arm is arranged more inside than an external end of the linear region. Rigidity of the carriage is decreased, which causes the resonance of the carriage. As a result, positioning accuracy of a head slider may be lowered.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary plan view of an internal structure of a hard disk drive (HDD) as a specific example of a storage medium driving device according to an embodiment of the invention;

FIG. 2 is an exemplary plan view of a structure of a carriage assembly in the embodiment;

FIG. 3 is an exemplary partial enlarged cross-sectional view taken along the line 3-3 of FIG. 1 in the embodiment;

FIG. 4 is an exemplary partial enlarged plan view of a structure of the carriage assembly in the embodiment;

FIG. 5 is an exemplary perspective view of a structure of the carriage assembly in the embodiment;

FIG. 6 is an exemplary partial enlarged perspective view of a structure of the carriage assembly in the embodiment;

FIG. 7 is an exemplary graph of frequency characteristics of an HDD according to a comparative example;

FIG. 8 is an exemplary graph of frequency characteristics of an HDD according to a specific example of the embodiment;

FIG. 9 is an exemplary graph of the gain of resonance mode with respect to the length of a support arm in the embodiment; and

FIG. 10 is an exemplary graph of the amplitude of in-plane mode with respect to a gap of a support arm and a linear region in the embodiment.

### DETAILED DESCRIPTION

Various embodiments according to the invention will be described hereinafter with reference to the accompanying drawings. In general, according to one embodiment of the invention, a carriage assembly comprises a carriage block body, a carriage arm, a coil, a pair of support arms, and a frame body. The carriage block body is configured to be rotatably connected to a spindle. The carriage arm is configured to extend forward from the front of the carriage block body. The coil is located behind the carriage block body, and is configured to define a linear region extending along a reference straight line extending radially from the center of the spindle. The support arms are configured to extend in parallel to the linear region from a back surface of the carriage block body. The frame body is made of a resin material, and is configured to fill between the coil and the support arms to couple the coil and the support arms. The support arms are configured to extend more outside than the external end of the linear region of the coil in the radial direction.

According to another embodiment of the invention, a storage medium driving device comprises a housing, a spindle, a carriage block body, a carriage arm, a head suspension, a head slider, a coil, a pair of support arms, and a frame body. The spindle is housed in the housing. The carriage block body is configured to be rotatably connected to the spindle. The carriage arm is configured to extend forward from the front of the carriage block body. The head suspension is configured to extend forward from the front end of the carriage arm. The head slider is configured to be supported by the head suspension. The coil is located behind the carriage block body, and is configured to define a linear region extending along a reference straight line extending radially from the center of the spindle. The support arms are configured to extend in parallel to the linear region from a back surface of the carriage block body. The frame body is made of a resin material, and is configured to fill between the coil and the support arms to couple the coil and the support arms. The support arms are configured to extend more outside than the external end of the linear region of the coil in the radial direction.

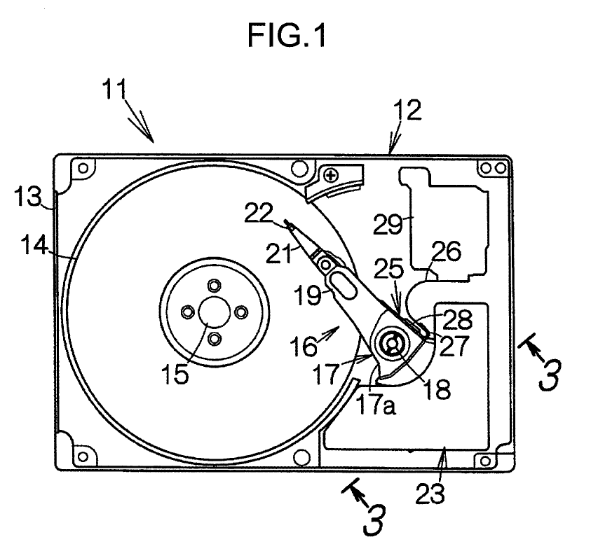

FIG. 1 schematically illustrates an internal structure of a hard disk drive (HDD) 11 as an example of a recording medium drive according to an embodiment of the invention. The HDD 11 comprises a housing 12. The housing 12 comprises a box-shaped base 13 and a cover (not illustrated). The base 13 defines, for example, an flat rectangular internal space, i.e., a housing space. The base 13 may be formed by casting with a metal material such as aluminum. The cover is coupled to an opening of the base 13. The housing space is sealed between the cover and the base 13. The cover may be formed by, for example, pressing a piece of plate.

In the housing space, one or more magnetic disks 14 as storage media are housed. The magnetic disk 14 is mounted on a spindle motor 15. The spindle motor 15 can rotate the magnetic disk 14 at high speed, such as 5400 rpm, 7200 rpm, 10000 rpm, and 15000 rpm.

In the housing space, a carriage assembly 16 is further housed. The carriage assembly 16 comprises a carriage block 17. The carriage block 17 comprises a carriage block body 17a that is rotatably coupled to a spindle 18 that extends in a vertical direction. With the carriage block body 17a, a plurality of carriage arms 19 are integrated. The carriage arms 19 extend forward from the front of the carriage block body 17a. The carriage block 17 may be formed by, for example, extruding aluminum.

Attached to the front end of each of the carriage arms 19 is a head suspension 21. The head suspension 21 may be attached by caulking. In caulking, a hole formed in the front end of the carriage arm 19 may be aligned with a hold formed in the rear end of the head suspension 21. At the front end of the head suspension 21, a flying head slider 22 is supported. On the flying head slider 22, a head device, i.e., an electromagnetic transducer device is mounted.

When an air flow is produced on a surface of the magnetic disk 14 by the rotation of the magnetic disk 14, positive pressure, i.e., buoyancy, and negative pressure act on the flying head slider 22 by the action of the air flow. When the buoyancy, the negative pressure, and a pressing force of the head suspension 21 are in balance, the flying head slider 22 can keep floating relatively firmly during the rotation of the magnetic disk 14.

When the carriage assembly 16 rotates about the spindle 18 while the flying head slider 22 is floating, the flying head slider 22 can move along a radius line of the magnetic disk 14. As a result, the electromagnetic transducer device on the flying head slider 22 can traverse a data zone between the innermost recording track and the outermost recording track. Thus, the electromagnetic transducer device on the flying head slider 22 can be positioned on a target recording track.

The carriage block 17 is connected to a power source such as a voice coil motor (VCM) 23. By the action of the VCM 23, the carriage block body 17a can rotate about the spindle 18. Such rotation of the carriage block body 17a enables reciprocation of the carriage arm 19 and the head suspension 21. The VCM 23 will be described in detail below.

As can be seen from FIG. 1, a flexible printed board unit 25 is arranged on the carriage block body 17a. The flexible printed board unit 25 comprises a flexible printed board 26. The flexible printed board 26 may be bonded to a surface of a metal plate 27, such as a stainless steel plate, with an adhesive. The metal plate 27 may be fixed to a side of the carriage block body 17a with, for example, a screw. The side of the carriage block body 17a is defined as a flat surface extending parallel to the spindle 18.

On the flexible printed board 26, a head integrated circuit (IC) 28 is mounted. When magnetic information is read, a sense current is supplied from the head IC 28 to a read head device of the electromagnetic transducer device. Similarly, when magnetic information is written, a write current is supplied from the head IC 28 to a write head device of the electromagnetic transducer device. To the head IC 28, a sense current or a write current is supplied from a compact circuit board 29 that is arranged in the housing space, or a printed wiring board (not illustrated) that is attached to the rear side of a bottom plate of the base 13.

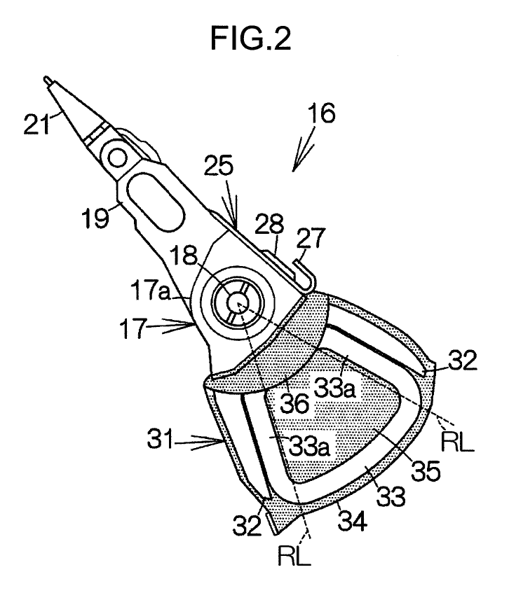

As illustrated in FIG. 2, the carriage block 17 comprises a coil support 31 that extends backward from the back surface of the carriage block body 17a. The coil support 31 comprises a pair of support arms 32. The support arms 32 are integrated with the carriage block body 17a. That is, the support arms 32 are made of aluminum. A voice coil 33 is arranged between the support arms 32. The voice coil 33 may be made of aluminum or a cladding material of copper and aluminum. In the voice coil 33, a linear region 33a is defined that extends along reference straight lines RL extending radially from the center of the spindle 18.

The support arm 32 and the voice coil 33 are coupled by a frame body 34 made of a resin material. The frame body 34 is filled between the support arm 32 and the voice coil 33. The voice coil 33 is wounded around a bobbin 35 made of a resin material. The bobbin 35 is filled in an internal space of the voice coil 33. The frame body 34 covers the outside of the support arm 32 and the external end of the voice coil 33. The frame body 34 defines a reinforcement piece 36 made of a resin material. The frame body 34 is integrated with the bobbin 35 by the reinforcement piece 36. The reinforcement piece 36 rises along the back surface of the carriage block body 17a from the front and rear surfaces of the voice coil 33. The bobbin 35 and the frame body 34 may be integrally molded from a resin material, such as polyphenylene sulfide (PPS) or a liquid crystal polymer (LCP). How to form the frame body 34 and the bobbin 35 will be described in detail below.

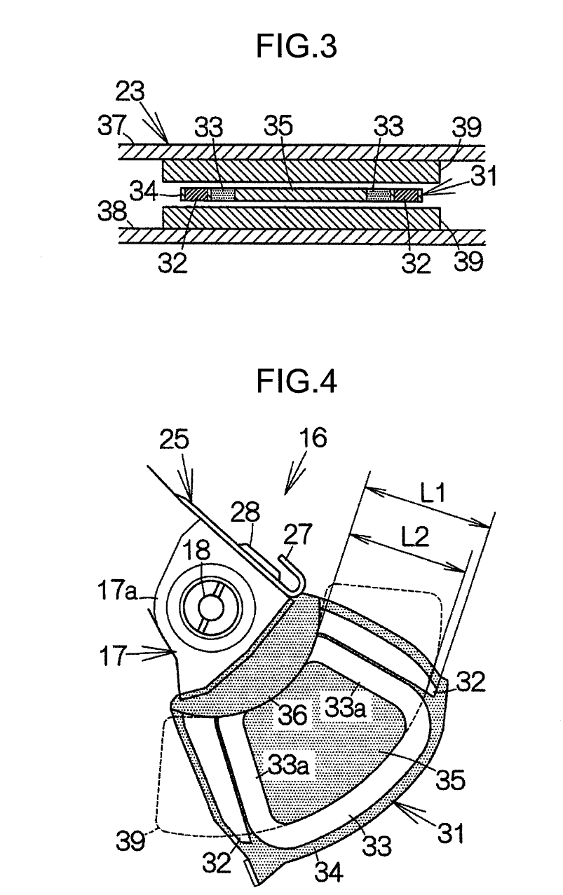

As illustrated in FIG. 3, the VCM 23 comprises an upper yoke 37 and a lower yoke 38 that are fixed on the base 13. To the upper yoke 37 and the lower yoke 38, a permanent magnet 39 is fixed. A magnetic field is generated between the upper yoke 37 and the lower yoke 38 by the action of the permanent magnet 39. When the VCM 23 is fixed, the coil support 31 is arranged between the upper yoke 37 and the lower yoke 38. Thus, the voice coil 33 is arranged in the magnetic field between the upper yoke 37 and the lower yoke 38. When the magnetic field is generated in the voice coil 33 by the supply of current, the carriage block body 17a rotates about the spindle 18. As can be seen from FIG. 3, the thickness of the frame body 34 defined in the center direction of the spindle 18 is set to be equal to the thickness of the support arm 32 or the thickness of the voice coil 33 similarly defined in the center direction of the spindle 18.

As illustrated in FIG. 4, the permanent magnet 39 extends while curving around the center of the spindle 18. The voice coil 33 faces the permanent magnet 39 in the linear region 33a. The support arm 32 linearly extends in parallel to the linear region 33a. An interval of the support arm 32 and the linear region 33a may be set to 0.5 mm or less. In this case, the interval is set to 0.3 mm. The support arm 32 extends more outside than the external end of the linear region 33a in the radial direction. That is, the length L1 of the support arm 32 is set to be longer than the length L2 of the linear region 33a.

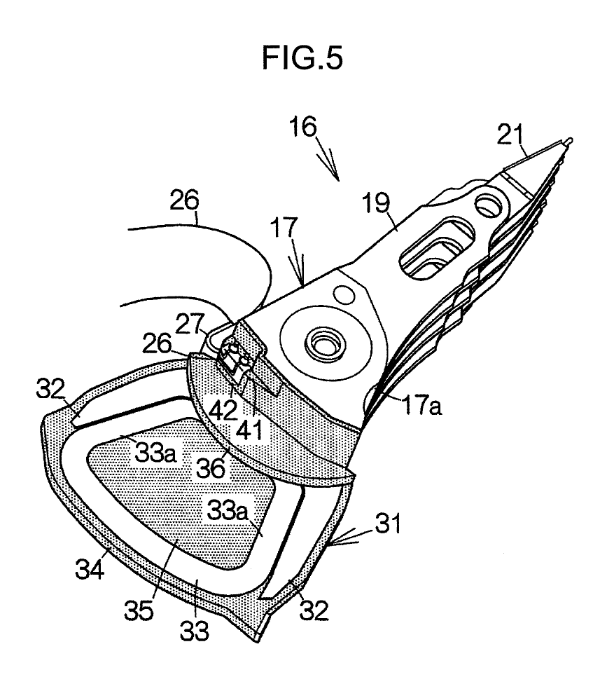

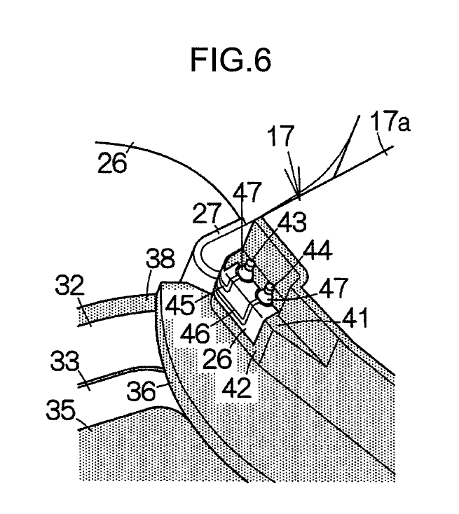

As illustrated in FIG. 5, in the reinforcement piece 36, a stepped surface 41 is defined along a virtual plane perpendicular to the center of the spindle 18 on more the base 13 side than the voice coil 33. The stepped surface 41 is connected to an erect surface 42. The erect surface 42 extends parallel to the center of the spindle 18. One end of the flexible printed board 26 overlaps the erect surface 42 and the stepped surface 41. Referring to FIG. 6, a first electrode 43 and a second electrode 44 protrude from the stepped surface 41. The first electrode 43 and the second electrode 44 are partially buried in the reinforcement piece 36. The first and second electrodes 43 and 44 are each formed of a conductive material such as copper.

In the reinforcement piece 36, one end and the other end of the voice coil 33 extend. In the reinforcement piece 36, one end of the voice coil 33 is wounded around the first electrode 43. Similarly, in the reinforcement piece 36, the other end of the voice coil 33 is wounded around the second electrode 44. Meanwhile, on the flexible printed board 26, a pair of first and second wiring patterns 45 and 46 are formed. The first wiring pattern 45 is electrically connected to the first electrode 43 through a solder material 47. Similarly, the second wiring pattern 46 is electrically connected to the second electrode 44 through the solder material 47. In this way, a current is supplied from the head IC 28 to the voice coil 33.

In the HDD 11, the support arm 32 extends in parallel to the linear region 33a of the voice coil 33. Similarly, the support arm 32 extends more outside than the external end of the linear region 33a in a radial direction. The rigidity of the coil support 31 is increased by the function of the support arm 32. According to verification described below, the gain of frequency characteristics of the coil support 31 substantially decreases. A resonance frequency of the carriage assembly 16 is increased, and a resonance of the carriage assembly 16 can be suppressed. Thus, the positioning accuracy of the flying head slider 22 is improved.

When the carriage assembly 16 is manufactured, the carriage block 17 after molding is arranged in a mold having a predetermined cavity. A gap is formed between the outside of the support arm 32 and an inner wall surface of the mold. In the mold, the voice coil 33 and the first and second electrodes 43 and 44 are arranged. One end and the other end of the voice coil 33 are previously connected to the first electrode 43 and the second electrode 44, respectively. The cavity of the mold is filled with a resin material. To the outside of the support arm 32, a resin material is flown. The resin material is hardened. Part of the first and second electrodes 43 and 44 and one end and the other end of the voice coil 33 are buried in the resin material. In this way, the coil support 31 is formed.

According to the above manufacturing method, when the coil support 31 is formed, one end and the other end of the voice coil 33 are previously wound around the first electrode 43 and the second electrode 44, respectively. One end and the other end of the voice coil 33 are prevented from being exposed to the outside of the reinforcement piece 36. If the position of the first electrode 43 and the second electrode 44 is specified in advance to a predetermined position on the reinforcement piece 36, the flexible printed board 26 can be easily aligned with the first electrode 43 and the second electrode 44. Accordingly, manufacturing process of the carriage assembly 16 is simplified. Thus, manufacturing cost of the carriage assembly 16 can be reduced.

Meanwhile, according to a conventional technology, one end and the other end of the voice coil 33 extend to the outside of the frame body 34. One end and the other end of the voice coil 33 are connected to a relaying flexible printed board at the outside of the frame body 34. The relaying flexible printed board is connected to the flexible printed board 26. The relaying flexible printed board is bonded to, for example, the frame body 34 by a two-sided tape. As a result, the manufacture of the carriage assembly 16 requires extra components, such as the relaying flexible printed board and the two-sided tape, resulting in higher manufacturing cost.

Further, in the carriage assembly 16, the frame body 34 covers the outside of the support arm 32. As a result, when the carriage assembly 16 is manufactured, a predetermined gap is formed between the outside of the support arm 32 and the inner wall surface of the mold. The gap is filled with a resin material. A burr of the resin material is prevented from being generated. Meanwhile, if the outside of the support arm 32 is exposed, the outside of the support arm 32 needs to contact the inner wall surface of the mold with high accuracy. As a result, if sufficient shape accuracy is not secured by the support arm 32 and the mold, the burr of the resin material may be generated at the outside of the support arm 32.

The inventors verified the effect of the support arm 32. For the verification, the inventors prepared a specific example and a comparative example. Specifically, the HDD 11 is used as the specific example. The length L1 of the support arm 32 was set to be longer than the length L2 of the linear region 33a of the voice coil 33. For an HDD of the comparative example, the length L1 of the support arm was set to half of the length L2 of the linear region. At this time, by the electromagnetic transducer device of the flying head slider, magnetic information was read from the magnetic disk. The frequency characteristics of vibration was analyzed based on the read magnetic information.

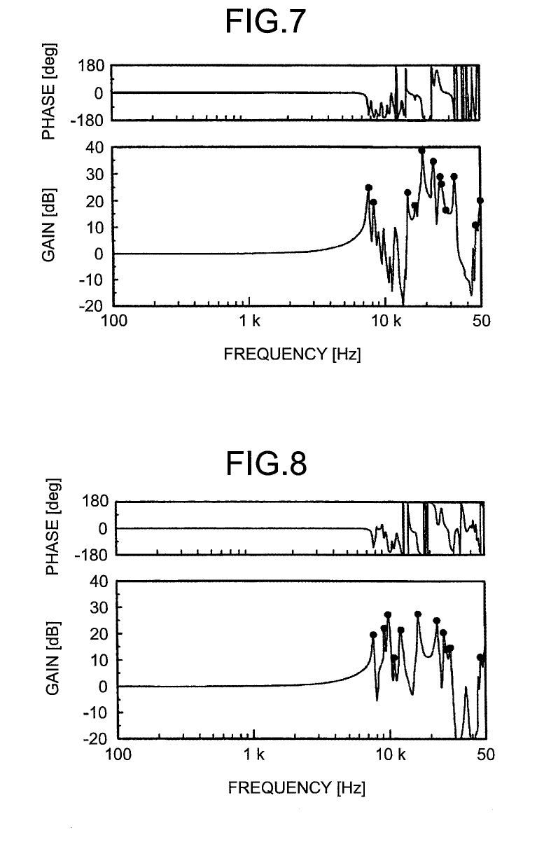

As a result, as illustrated in FIG. 7, in the HDD of the comparative example, a main resonance point was specified at a position of 7.6 kHz. Meanwhile, as illustrated in FIG. 8, in the HDD 11 of the specific example, a main resonance point was specified at a position of 9.8 kHz. The resonance frequency increased. As compared with the comparative example, the gain of the frequency decreased, and an increase/decrease in gain at a high frequency band was suppressed. Accordingly, it was confirmed that the resonance of the coil support 31, i.e., the carriage assembly 16, was suppressed when the support arm 32 was arranged more outside than the external end of the linear region 33a in the radial direction.

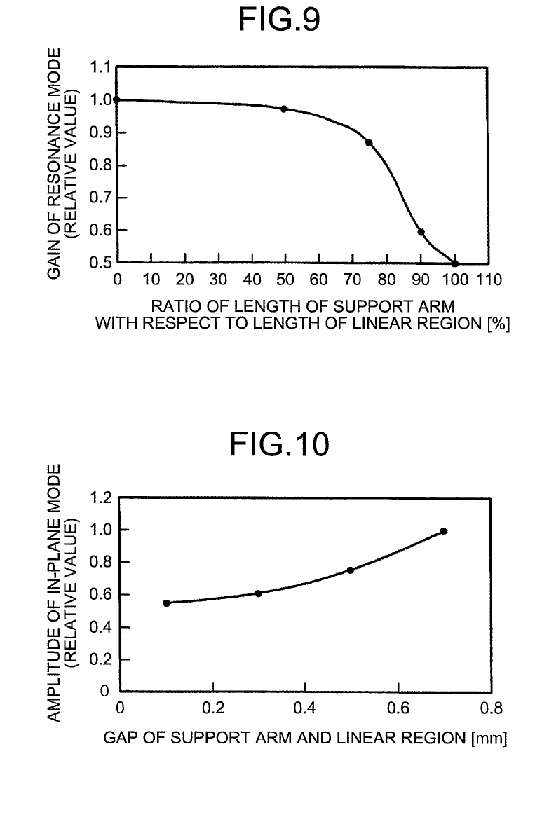

Next, the inventors verified a relationship between the length of the support arm 32 and the gain of resonance mode of the coil support 31. At the time of the verification, a simulation was performed based on the finite element method. As a result, as illustrated in FIG. 9, it was found that the gain of the resonance mode substantially decreased when the length of the support arm 32 increased. In particular, when the length of the support arm 32 was equal to the length of the linear region 33a (100%), the gain was reduced to half as compared with when the support arm 32 was not formed (0%). Thus, it was confirmed that the gain of the resonance mode substantially decreased when the support arm 32 extended more outside than the external end of the linear region 33a in the radial direction.

Next, the inventors verified a relationship between the gap of the support arm 32 and the linear region 33a and the amplitude of in-plane mode of the voice coil 33. At the time of the verification, a simulation was performed based on the finite element method. The amplitude was specified in a virtual plane perpendicular to the center of the spindle 18. As a result, as illustrated in FIG. 10, it was found that the amplitude of the in-plane mode decreased when the gap of the support arm 32 and the linear region 33a decreased. Thus, it was confirmed that the gap of the support arm 32 and the linear region 33a was preferably set as small as possible.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A carriage assembly comprising:
a carriage block body connected to a spindle and configured to rotate around the spindle;
a carriage arm configured to extend from front of the carriage block body;
a coil behind the carriage block body, the coil configured to define a linear region extending along a reference straight line extending radially from a center of the spindle;
a pair of support arms configured to extend in parallel to the linear region from a back surface of the carriage block body; and
a frame comprising a resin material between the coil and the support arms, and configured to couple the coil and the support arms, wherein
the support arms are configured to extend outside of an external end of the linear region of the coil in a radial direction.

2. The carriage assembly of claim 1, wherein the frame is configured to cover outside of the support arms.

3. The carriage assembly of claim 1, further comprising:
a first electrode partially in the frame and connected to a first end of the coil in the frame; and
a second electrode partially in the frame and connected to a second end of the coil in the frame.

4. A storage medium driving device comprising:
a housing;
a spindle in the housing;
a carriage block body connected to the spindle and configured to rotate around the spindle;
a carriage arm configured to extend from front of the carriage block body;
a head suspension configured to extend from a front end of the carriage arm;
a head slider supported by the head suspension;
a coil behind the carriage block body, the coil configured to define a linear region extending along a reference straight line extending radially from a center of the spindle;
a pair of support arms configured to extend in parallel to the linear region from a back surface of the carriage block body; and
a frame comprising a resin material between the coil and the support arms, and configured to couple the coil and the support arms, wherein
the support arms are configured to extend outside of an external end of the linear region of the coil in a radial direction.

5. The storage medium driving device of claim 4, wherein the frame is configured to cover outside of the support arms.

6. The storage medium driving device of claim 4, further comprising:
a first electrode partially in the frame and connected to a first end of the coil in the frame; and
a second electrode partially in the frame and connected to a second end of the coil in the frame body.
